(19) United States
(12) Patent Application Publication
(10) Pub. No.: US 2014/0226104 A1
(43) Pub. Date: Aug. 14, 2014

(54) LIQUID CRYSTAL DISPLAY DEVICE

(71) Applicant: Takaharu Kikuchi, Osaka-shi (JP)

(72) Inventor: Takaharu Kikuchi, Osaka-shi (JP)

(73) Assignee: SHARP KABUSHIKI KAISHA, Osaka-shi, Osaka (JP)

(21) Appl. No.: 14/117,293

(22) PCT Filed: Apr. 2, 2012
(86) PCT No.: PCT/JP2012/058852

§ 371 Date: Nov. 12, 2013

(30) Foreign Application Priority Data
May 13, 2011 (JP) 2011-107727

(51) Int. Cl. G02F 1/1333

(52) U.S. Cl. CPC G02F 1/133382
USPC 349/58

(57) ABSTRACT

Provided is a technology that, in a liquid crystal display device, reduces the effect on display quality of heat that an IC or the like generates. A sheet group 50 and a backlight chassis 60 are arranged essentially in close contact. Furthermore, a drawing portion 62 of a predetermined depth is formed at the backlight chassis 60 at a position corresponding to the attachment part of IC 80. Consequently, the backlight chassis 60 and the sheet group 50 are in close contact at the regions other than the drawing portion 62, but are separated by a heat-insulating space 68 formed between the two at the drawing portion 62. Also, the IC 80 attached to the bottom side of a circuit board 70 is in close contact to the upper face of the drawing portion 62.

### TECHNICAL FIELD

The present invention relates to a liquid crystal display device and, for example, relates to a thin liquid crystal display device which is suitable for a liquid crystal television etc. and a tablet display device.

### BACKGROUND ART

In recent years, televisions have become thinner and more lightweight, and televisions which are movable by carrying even if a display size is 20 inches have become introduced on the market. Thus, each manufacturing company has introduced various inventions on products to make televisions thinner and more lightweight. As a kind of such technologies, there is a technology for arranging a screw after a backlight chassis portion is subjected to drawing processing (refer to Patent Literature 1). In a liquid crystal module of this technology, a liquid crystal cell is arranged on a front face of a rectangular-frame-shaped mold frame that is provided with a backlight therein. Further, a backlight chassis that is made of metal is fixed on a rear face of the backlight via a reflecting sheet made of synthetic resin. Moreover, the liquid crystal cell is formed to be illuminated from backward by the backlight, a plurality of support bases are formed on the backlight chassis at predetermined intervals, and a board is fixed to each of the support bases by screwing. In addition, the backlight chassis is subjected to drawing processing so that each of the support bases is swollen backward. This technology makes it possible to save the number of components and labor of processing.

### CITATION LIST

### Patent Literature

PATENT LITERATURE 1: Japanese Laid-Open Patent Publication No. 2006-227057

### SUMMARY OF INVENTION

### Technical Problem

In the meantime, as improvement in the image quality has also advanced at the same time, there are also many cases where many heat sources are arranged inside a display device (in a set) by mounting a high-performance image processing IC in a thin housing or the like. In general, in a liquid crystal television and the like, a liquid crystal panel is by a physical operation of a liquid crystal element in liquid and is therefore likely to be affected by temperature greatly. In the case of temperature change for the entire liquid crystal panel, it is possible to cope with the change by detection with a temperature sensor to finely adjust control of the entire panel. However, as to partial temperature change, there is a problem that it is difficult to cope with the change and improvement has been required. In the case of a portable television which is thin and lightweight, it is strongly requested from the market to make thinner to the limit. Therefore, distance between a circuit board and a backlight chassis is much closer than a general television which is expected to be stationary. Thereby, for example, in an image processing IC on a board or an IC performing high-speed processing such as a microcomputer, the temperature becomes high. When this IC comes close to the backlight chassis for thinning, a part of the backlight chassis is made to be heated at high temperature. Then, in the case of an edge-type backlight, since the backlight chassis and the liquid crystal panel come close to each other, the heat is transferred to the panel as it is. Thus, a part of the liquid crystal panel makes a different response from other parts, so that symptoms such as whitish dots of a vide image occur. Improvement for such symptoms has been requested.

Moreover, for the technology disclosed in PATENT LITERATURE 1, when the backlight is in a direct type, since there is distance between the backlight chassis and the liquid crystal panel and there is an airspace, it is usually the case that the heat of the board is dissipated to the backlight chassis, and no problem is caused. In a structure where a sheet group including the liquid crystal panel and the like and the backlight chassis are in close contact to each other, the heat problem as described above becomes conspicuous and other technology has been requested.

The present invention has been made in view of such circumstances and aims to provide a technology for reducing the effect on display quality of heat that an IC or the like generates in a thin display device.

### Solution to Problem

A device according to the present invention is a liquid crystal display device that a sheet group including a liquid crystal panel and a backlight chassis are arranged in close contact, in which the backlight chassis includes a process face which is not in close contact to the sheet group, and a heat generating component of a circuit board is fixed to the process face.

Moreover, the process face may be formed to be swollen to an opposite side of the sheet group by drawing processing.

Moreover, the process face may have a larger area than a fixed face of the heat generating component.

### Advantageous Effects of Invention

According to the present invention, it is aimed to provide a technology for reducing the effect on display quality of heat that an IC or the like generates in a liquid crystal display device.

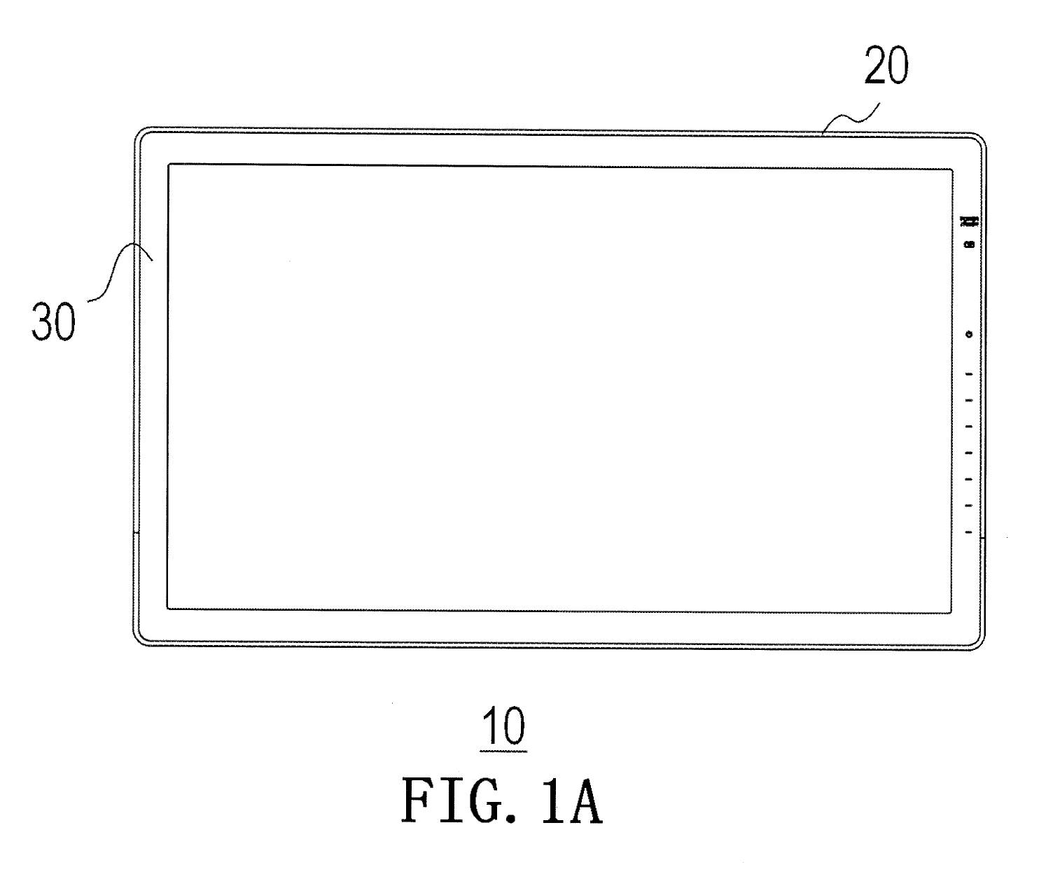

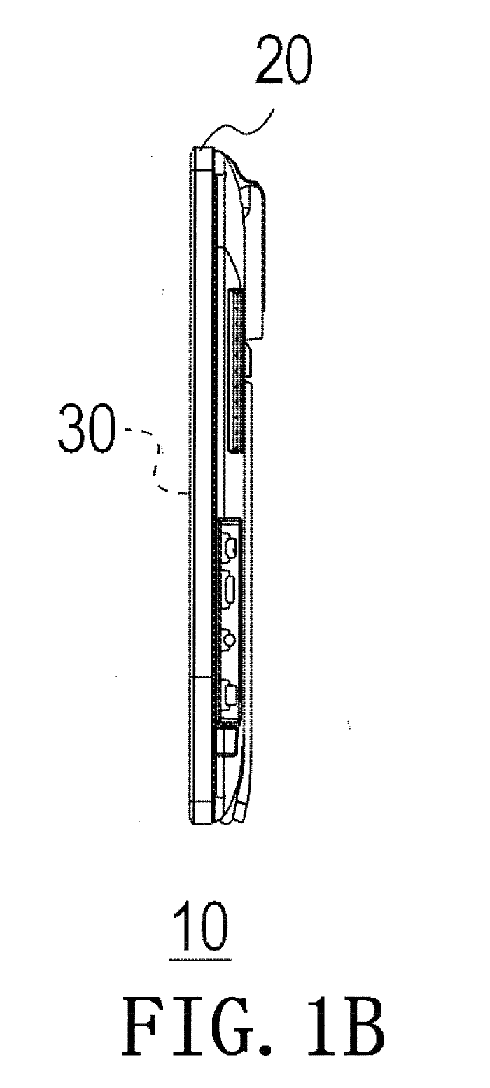

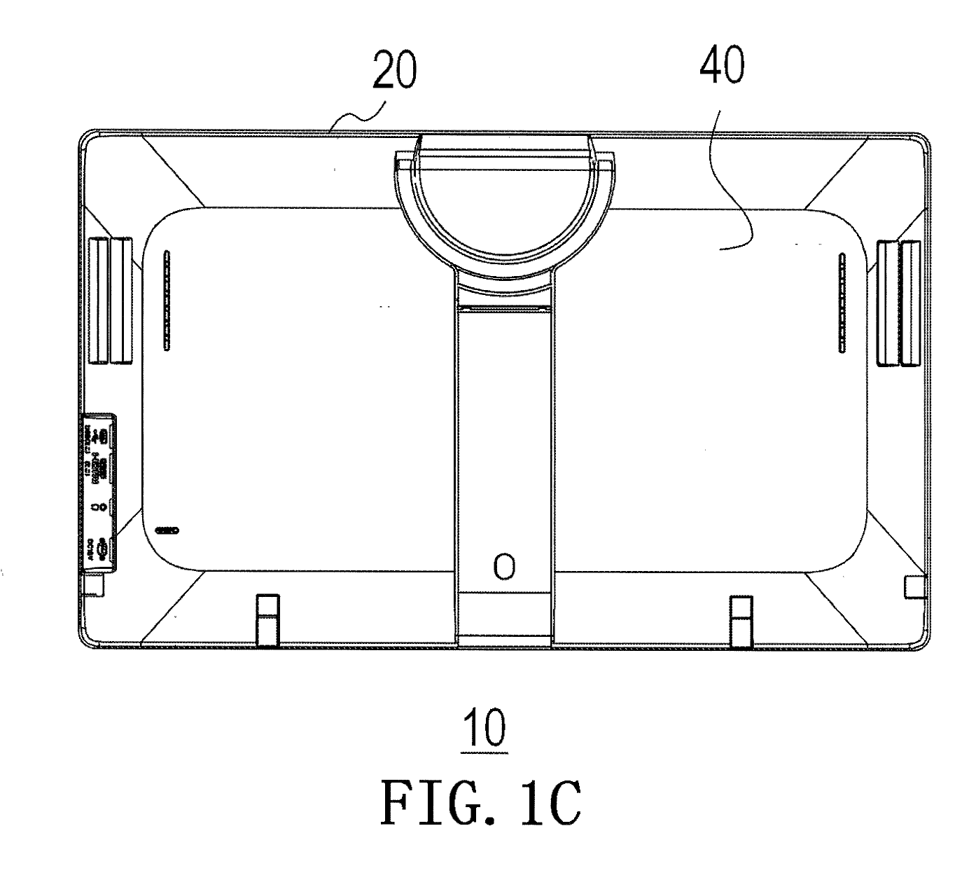

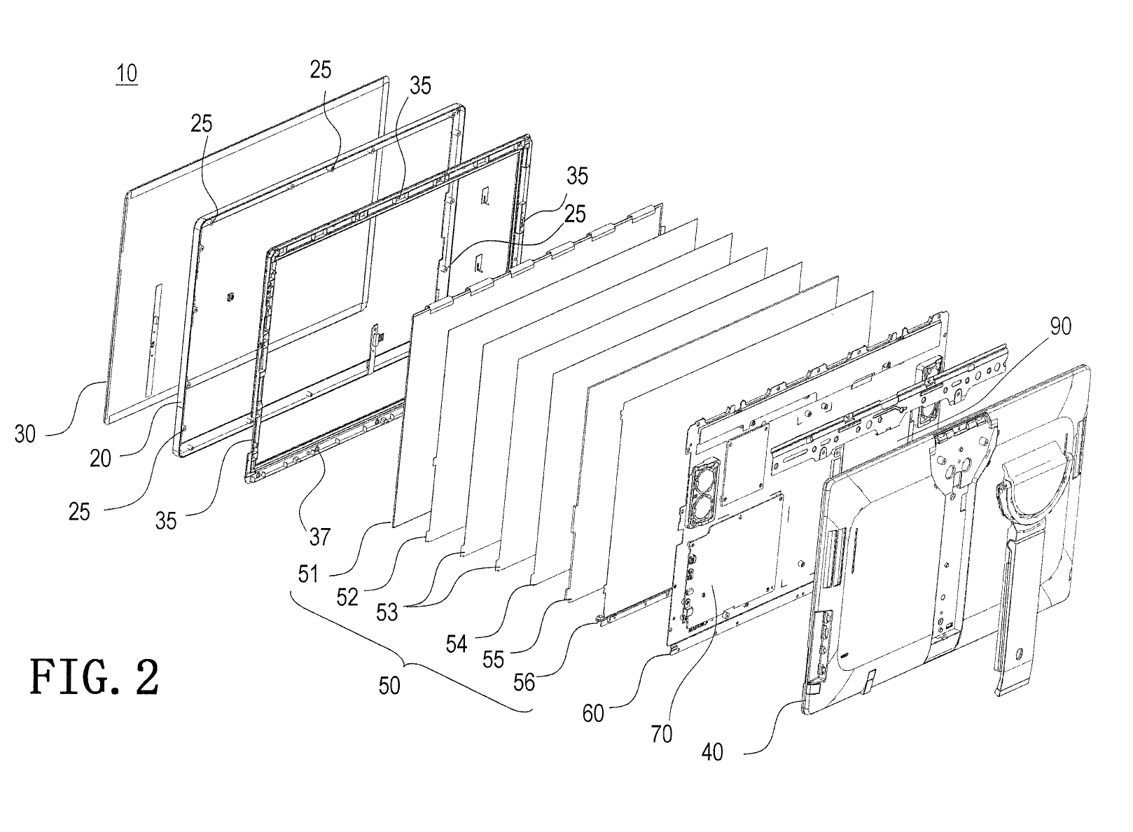

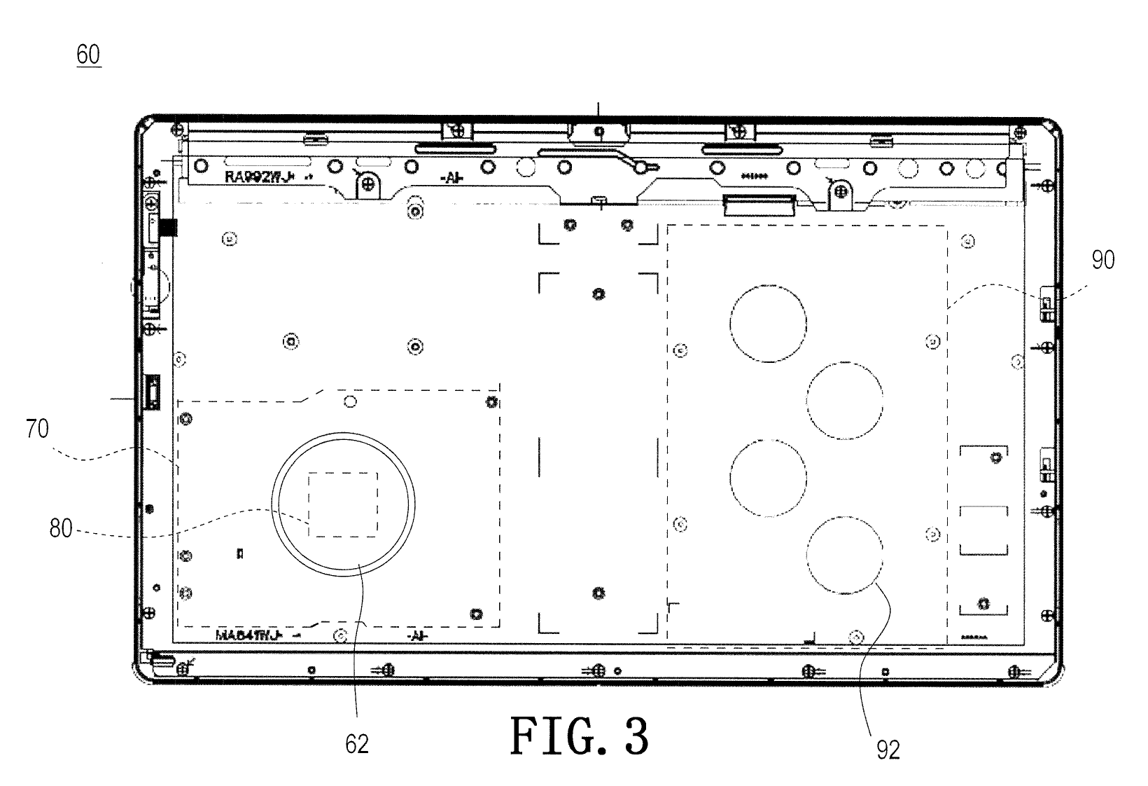

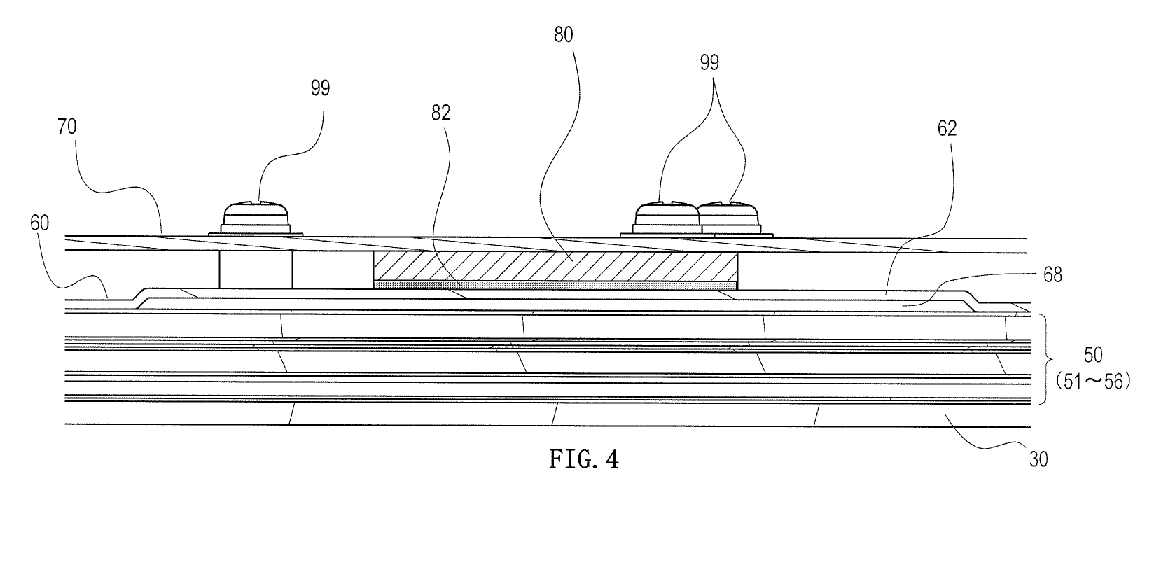

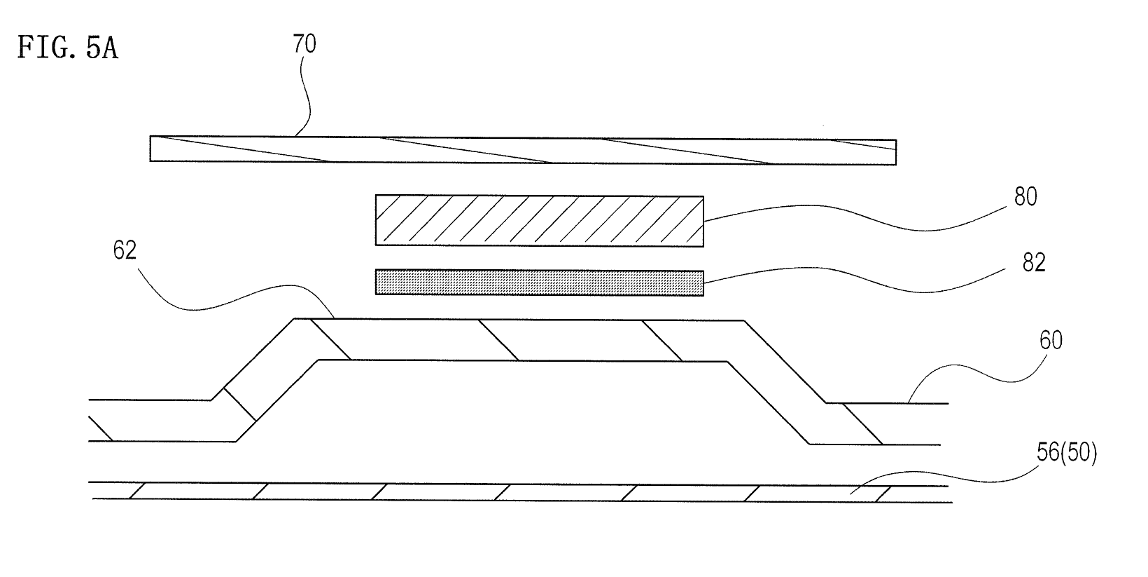

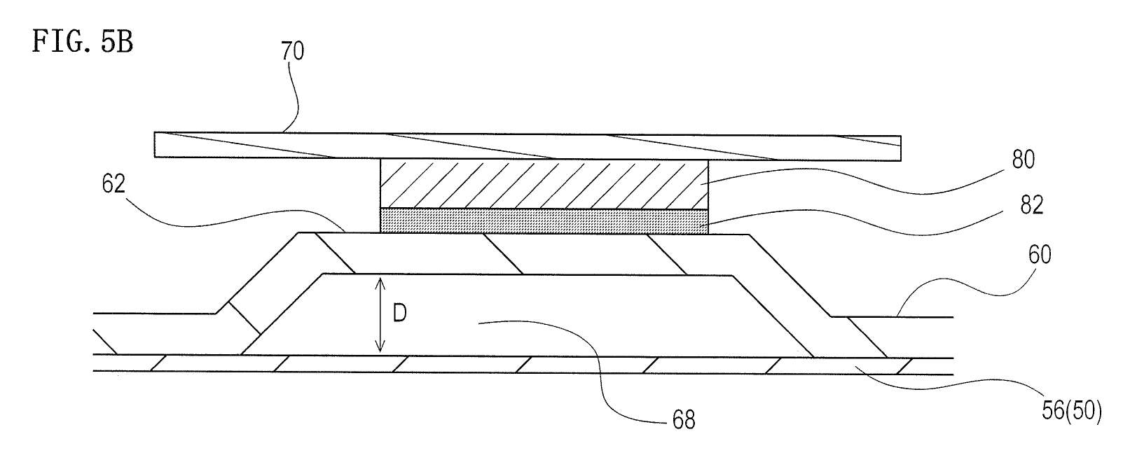

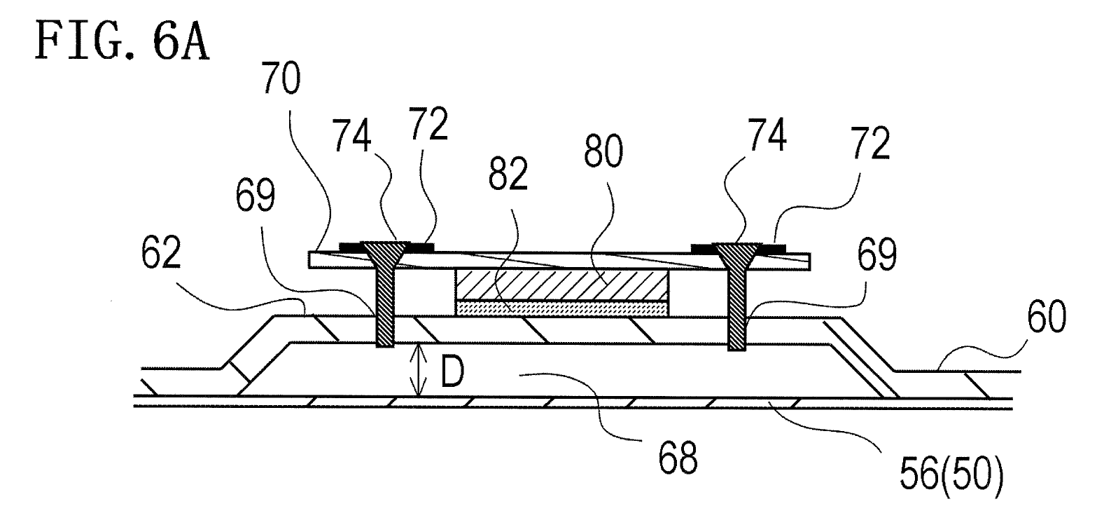

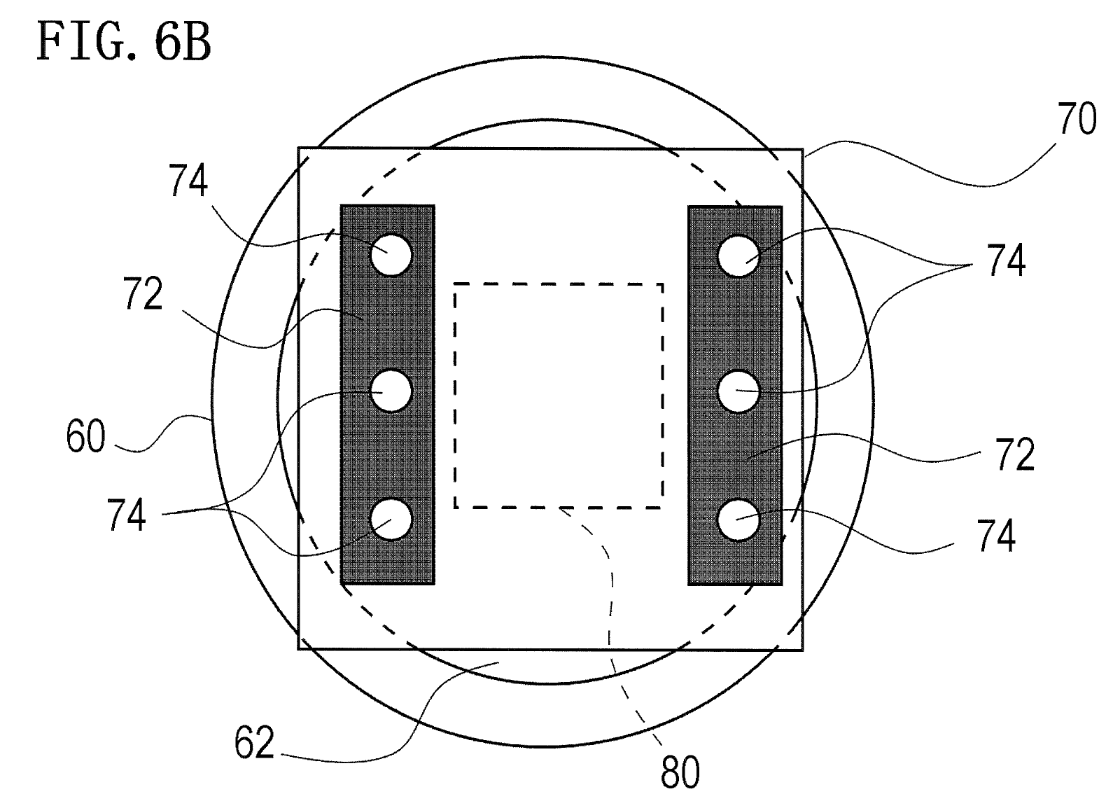

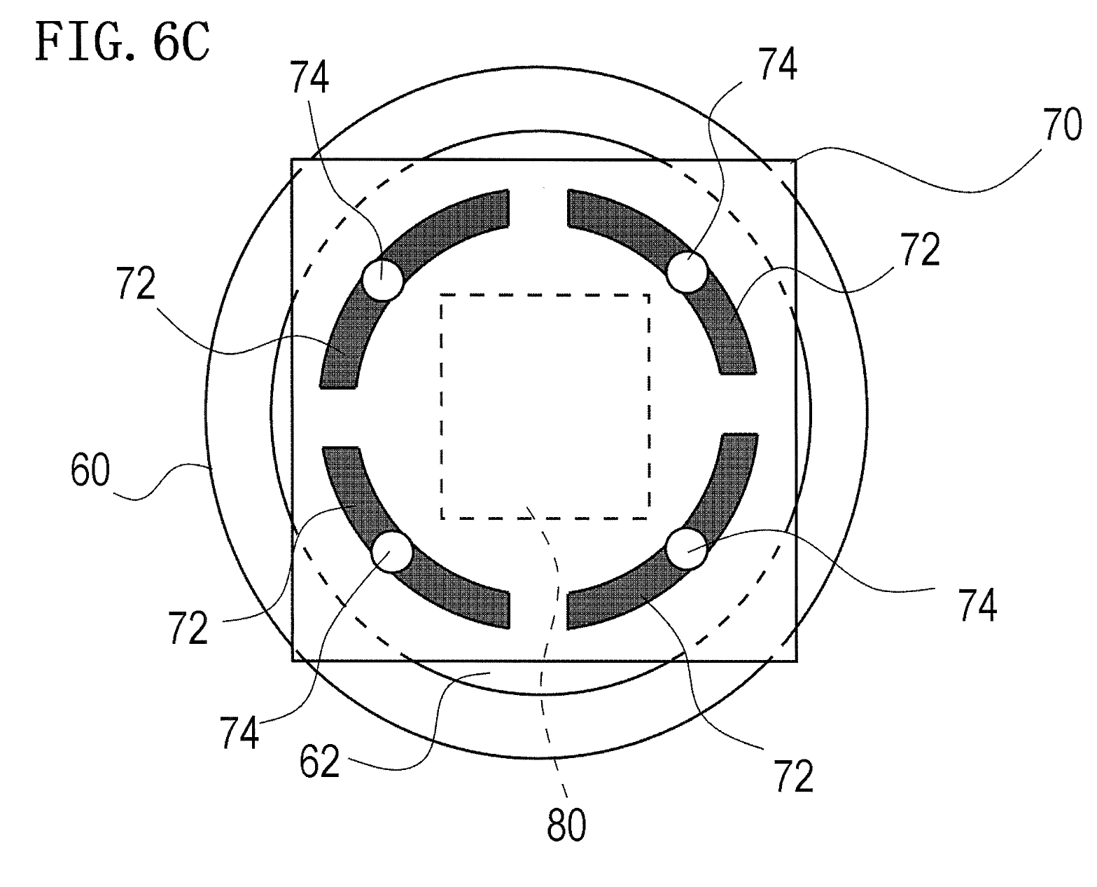

### BRIEF DESCRIPTION OF DRAWINGS

[FIG. 1A] is a plan view showing an appearance of a liquid crystal television according to an embodiment.

[FIG. 1B] is a side view showing an appearance of a liquid crystal television according to an embodiment.

[FIG. 1C] is a rear view showing an appearance of a liquid crystal television according to an embodiment.

[FIG. 2] is an exploded perspective view showing an appearance of the liquid crystal television according to the embodiment.

[FIG. 3] is a rear view of a backlight chassis according to the embodiment.

[FIG. 4] is a cross-sectional view specifically showing a fixed part of an IC and the backlight chassis according to the embodiment.

[FIG. 5A] is a cross-sectional view schematically showing the fixed part of the IC and the backlight chassis according to the embodiment.

[FIG. 5B] is a cross-sectional view schematically showing the fixed part of the IC and the backlight chassis according to the embodiment.

[FIG. 6A] is a cross-sectional view schematically showing the fixed part of the IC and the backlight chassis according to a modified example of the embodiment.

[FIG. 6B] is a plan view corresponding to the cross-sectional view of FIG. 6A according to a modified example of the embodiment.

[FIG. 6C] is a plan view corresponding to the cross-sectional view of FIG. 6A according to a modified example of the embodiment.

### DESCRIPTION OF EMBODIMENTS

Next, description will be given specifically for modes for carrying out the present invention with reference to drawings. The following explains as an example a liquid crystal television as a thin liquid crystal display device, however, of course, it is also possible to apply to a liquid crystal monitor and a mobile terminal (a mobile phone or a tablet display device).

A summary of the points of the present embodiment is as follows.

By adding a drawing structure to a part of a backlight chassis, a sheet group including a reflection sheet, a light guide plate and the like and the backlight chassis have a space formed therebetween to be separated. By making an IC (integrated circuit) which is a kind of a heat generating component contact to the drawing structure part which is a kind of a process face, that is, by forming drawing so as to be just below the IC of a circuit board, the heat transferred from the IC to the backlight chassis is prevented from being transferred to the sheet group including the light guide plate, a panel and the like as it remains at high temperature. Moreover, the drawing structure is formed wider than an area of a connection part of the IC. Note that, as the process face, the drawing structure is exemplified as a general process form in the backlight chassis, but the present invention is not limited to this, and a process form such as cutting depending on material or the like may be used. Moreover, though the IC is exemplified as the heat generating component, various components which generate heat with driving of a liquid crystal television 10, for example, a battery and an inverter component are also applicable.

FIG. 1 are views showing an appearance of the liquid crystal television 10 according to the present embodiment. Moreover, FIG. 2 is an exploded perspective view of the liquid crystal television 10. The liquid crystal television 10 is provided with as an exterior a frame-shaped frame 20 which is an exterior side face cabinet, a transparent protection cover 30 on the front side, and a rear cabinet 40 on the rear side. In addition, inside the exteriors, a front cabinet frame 35, a sheet group 50 and a backlight chassis 60 are arranged from the side of the transparent protection cover 30.

The frame 20 is a molded component by a metallic processing member (by processing extruded material or drawing material). Though description will be given below for the detailed structure, for example, in the case of a 20-inch class, a rough size is about 490 mm width×about 290 mm height.

The transparent protection cover 30 is, for example, a glass plate and protects the sheet group 50. The rear cabinet 40 is molded with resin material.

The front cabinet frame 35 is molded with resin material to have the substantially same size and shape with the frame 20, and is attached to the rear face side of the frame 20. Note that, in the frame 20, a cylindrical positioning projection portion 25 is formed at a predetermined position to extend in a back direction. On the front face side of the front cabinet frame 35, a positioning boss hole 37 is provided corresponding to the positioning projection portion 25.

The sheet group 50 has a liquid crystal panel 51, a Df sheet 52, a lens sheet 53, a light guide plate 54, a diffusion sheet 55, and a reflection plate 56 arranged in a laminated form from the front side.

The backlight chassis 60 is such that a metallic plate-shaped body is processed to have a predetermined shape, in which a not-shown light source (for example, an LED edge light), a video image driving circuit (circuit board 70), a battery 90 and the like are arranged. As will be described below, at an attachment part of the circuit board 70, an IC 80 is fixed to the backlight chassis 60 for heat radiation.

Subsequently, description will be given for the fixing structure of the backlight chassis 60 and the IC 80, which is characteristic to the present embodiment.

FIG. 3 is a rear view of the backlight chassis 60 (view on the side of the rear cabinet 40) according to the present embodiment. As illustrated, on the side of the rear cabinet 40 of the backlight chassis 60, the circuit board 70 is attached in a region on the lower left side in the figure. Moreover, in a region on the right side in the figure, a plurality of holes 92 for adjusting heat transfer are provided and the thin battery 90 is provided so as to cover these holes 92. Further, in a region where the circuit board 70 is attached, a drawing portion 62 is formed so that the IC 80 of the circuit board 70 is able to contact thereto. The drawing portion 62 is formed in a circular shape as viewed from above, and is provided with an attachment face which is large enough to the IC 80.

FIG. 4 is a cross-sectional view showing a state where the IC 80 of the circuit board 70 is attached to the drawing portion 62. Moreover, FIGS. 5A and 5B schematically show the attachment structure of the drawing portion 62 and the IC 80 of FIG. 4 in an easy-to-understand manner. Note that, the lower side in the figure corresponds to the front side of the liquid crystal television 10, and the upper side in the figure corresponds to the rear side of the liquid crystal television 10. The IC 80 is attached to the lower side of the circuit board 70. The circuit board 70 is fixed to the backlight chassis 60 by a screw 99. When the circuit board 70 is fixed, then a face on the lower side of the IC 80 is fixed to the drawing portion 62 in close contact.

As shown in FIG. 4, the sheet group 50 and the backlight chassis 60 are arranged essentially in close contact. Furthermore, the drawing portion 62 with a predetermined depth D is formed at a position corresponding to the attachment part of the IC 80 of the backlight chassis 60. Consequently, the backlight chassis 60 and the sheet group 50 are in close contact to each other at the regions other than the drawing portion 62, but are separated by a heat-insulating space 68 formed between the two at the region of the drawing portion 62.

Also, the IC 80 attached on the lower side of the circuit board 70 (the front side of the liquid crystal television 10) is in close contact to the upper face of the drawing portion 62 in the figure (the face on the rear side of the liquid crystal television 10). Note that, a heat radiation sheet 82 is used between the IC 80 and the drawing portion 62 for securing reliable close contact and appropriate heat transfer efficiency.

Hereinabove, according to the embodiment, since the drawing portion 62 is formed and the heat-insulating space 68 exists, it is possible to reduce transfer of the heat at high temperature of the IC 80 arranged in the circuit board 70 from the backlight chassis 60 to the sheet group 50 (liquid crystal panel 51) as it remains at high temperature. As a result, it is possible to avoid occurrence of phenomenon of white dots in display of the liquid crystal panel 51.

Hereinabove, the present invention has been described on the basis of the embodiment. This embodiment provides only an exemplification, and any person with an ordinary skill in the art could understand that, various modified examples can be made to combining of each of the components thereof, and such modified examples are also within the scope of the present invention. For example, from the point of view of reduction of processing distortions occurring with drawing processing, the drawing portion 62 is preferably in a circular shape as described above, but when an amount of drawing processing is small and occurrence of distortions is less, other shape such as a rectangular shape may be selected. Moreover, an area of the drawing portion 62 is secured to be wider than the face on the lower side of the IC 80, but when the phenomenon of white dots does not occur upon consideration of a relation of an amount of heat generation and an area of the actual heat generating part and the like, may be set to be narrower than the face on the lower side of the ICC 80. Further, a hole shape for adjusting heat transfer may be formed. Additionally, the drawing portion 62 is formed by drawing processing as described above, but without limitation thereto, for example, as the rear face side remains in flat, the front face side is subjected to cutting processing to form the heat-insulating space 68.

In addition, another modified example is shown in FIG. 6. FIG. 6 are cross-sectional views and a plan view schematically showing the fixed part of the IC 80 and the backlight chassis 60 according to the modified example. The plan view of FIG. 6B is a view corresponding to the cross-sectional view of FIG. 6A. In addition, FIG. 6C shows a further modified example of the plan view of FIG. 6B. As shown in FIG. 6A and FIG. 6B, on the upper face of the circuit board 70 in the figure, two heat radiation patterns 72 are formed to sandwich the IC 80 therebetween. The heat radiation pattern 72 is a thin-film metal such as copper. In addition, a screw hole 69 is formed in a predetermined region of the drawing portion 62, and the circuit board 70 is connected to the drawing portion 62 by the heat radiation screw 74. At this time, a screw portion of the heat radiation screw 74 is fastened on the screw hole 69, and a countersunk head part of the heat radiation screw 74 is connected to the region of the heat radiation pattern 72. As a result, the heat of the drawing portion 62 is able to be dissipated to the side of the circuit board 70 via the heat radiation screw 74. Note that, the heat radiation pattern 72 is not particularly limited in the shape, and may be formed in a circular arc shape (in quarters in the figure) as shown in FIG. 6C. Moreover, a metallic plate-shaped body may be used instead of the heat radiation screw 74. Such a structure makes it possible to lower height D of a space of the heat-insulating space 68. Further, the heat radiation pattern 72 may be provided on the face on the side where the IC 80 is arranged.

### Reference Signs List

10 liquid crystal television

20 frame

25 positioning projection portion

30 transparent protection cover

35 front cabinet frame

37 positioning boss hole

40 rear cabinet

50 sheet group

51 liquid crystal panel

52 Df sheet

53 lens sheet

54 light guide plate

55 diffusion sheet

56 reflection plate

60 backlight chassis

62 drawing portion

68 heat-insulating space

69 screw hole

70 circuit board

72 heat radiation pattern

74 heat radiation screw

80 IC

82 heat radiation sheet

90 thin battery

92 hole

99 screw

1. A liquid crystal display device that a sheet group including a liquid crystal panel and a backlight chassis are arranged in close contact, wherein
the backlight chassis includes a process face which is not in close contact to the sheet group, and
a heat generating component of a circuit board is fixed to the process face.

2. The liquid crystal display device as defined in claim 1, wherein
the process face is formed to be swollen to an opposite side of the sheet group by drawing processing.

3. The liquid crystal display device as defined in claim 1, wherein
the process face has a larger area than a fixed face of the heat generating component.

4. The liquid crystal display device as defined in claim 2, wherein
the process face has a larger area than a fixed face of the heat generating component.
